(19) United States
(12) Patent Application Publication
(10) Pub. No.: US 2016/0298026 A1
(43) Pub. Date: Oct. 13, 2016

(54) HARD AND SALT WATER RESISTANT SELF SUSPENDING PROPPANTS

(71) Applicant: Self-Suspending Proppant LLC, Cambridge, MA (US)

(72) Inventors: Moustafa Aboushabana, Stafford, TX (US); Kanth V. Josyula, Sugar Land, TX (US); Huaxiang Yang, Sugar Land, TX (US); Vinay R. Mehta, Richmond, TX (US)

(21) Appl. No.: 15/091,987

(22) Filed: Apr. 6, 2016

Related U.S. Application Data
(60) Provisional application No. 62/144,775, filed on Apr. 8, 2015.

(51) Int. Cl. C09K 8/80; E21B 43/267; C09K 8/90; E21B 43/26; C09K 8/68; C09K 8/88

(52) U.S. Cl. CPC C09K 8/805; C09K 8/685; C09K 8/887; C09K 8/90; E21B 43/26; E21B 43/267

(57) ABSTRACT

A self-suspending proppant comprises a proppant particle substrate and a coating on the proppant particle substrate comprising chitosan or a chitosan analog, wherein the coating has been applied to the proppant particle substrate of the proppant by means of an alkaline solution or emulsion.

### CROSS REFERENCE TO RELATED APPLICATION

This application claims the benefit of U.S. Provisional Application No. 62/144,775, filed Apr. 8, 2015, which disclosure is incorporated by reference in its entirety.

### BACKGROUND

In commonly assigned applications Ser. No. 13/599,828, filed Aug. 30,2012, Ser. No. 13/838,806, filed Mar. 15, 2013, Ser. No. 13/939,965, filed Jul. 11, 2013, Ser. No. 14/197,596, filed Mar. 5, 2014, and Ser. No. 61/948,212, filed Mar. 5, 2014, there are described self-suspending proppants which take the form of a proppant particle substrate carrying a coating of a hydrogel-forming polymer. As further described there, these proppants are formulated in such a way that they rapidly swell when contacted with aqueous fracturing fluids to form hydrogel coatings which are large enough to significantly increase the buoyancy of these proppants during their transport downhole yet durable enough to remain largely intact until they reach their ultimate use locations. The disclosures of all of these earlier applications are incorporated herein by reference in their entireties.

Preferably, these self-suspending proppants are also free-flowing when dry. In this context, “dry” will be understood to mean that these proppants have not been combined with a carrier liquid such as would occur if they were present in an a fracturing fluid or other suspension or slurry. In addition, “free-flowing” will be understood to mean that any clumping or agglomeration that might occur when these proppants are stored for more than a few days can be broken up by gentle agitation.

It is well known that calcium and other divalent ions can substantially retard the ability of anionic hydrogel-forming polymers to swell when contacted with water. In this context, an “anionic hydrogel-forming polymer” will be understood to mean a hydrogel forming polymer whose hydrogel-forming properties are primarily due to pendant carboxylic groups but may also be due to other anionic groups such as sulfonate, phosphonate, sulfate and phosphate groups. This problem can be particularly troublesome when such polymers are used in hydraulic fracturing applications, because the source water used to make up the fracturing fluids used for this purpose, as well as the geological formation water encountered downhole, often contain significant quantities of these ions. To this end, the self-suspending proppants of our earlier disclosures can also be adversely affected by these ions, as reflected by a reduction in the degree to which these proppants swell and hence the degree to which they become self-suspending when contacted with their aqueous fracturing fluids.

### SUMMARY

In accordance with this invention, we have found that the tendency of calcium and other divalent ions to adversely affect the swelling properties of hydrogel-forming polymers used to make self-suspending proppants can be lessened significantly by (1) selecting as the hydrogel-forming polymer chitosan or other naturally occurring cationic polymer such as a cationic polysaccharide, (2) by applying a coating of this hydrogel-forming polymer on the proppant particle substrate of the proppant by means of an alkaline solution or emulsion, and optionally and preferably (3) by pretreating the proppant particle substrate with a silane coupling agent which includes a reactive functional group capable of reacting with the pendant amino groups on the chitosan molecule or the analogous pendant electronegative group of chitosan analog.

Thus, this invention provides a self-suspending proppant comprising a proppant particle substrate and a coating on the proppant particle substrate comprising chitosan or other naturally occurring cationic polymer such as a cationic polysaccharide, wherein the coating has been applied to the proppant particle substrate of the proppant by means of an alkaline solution or emulsion, and further wherein prior to application of this coating the proppant particle substrate is optionally treated with a silane coupling agent which includes a reactive functional group capable of reacting with the pendant amino groups on the chitosan molecule or the analogous pendant electronegative group of chitosan analog.

In addition, this invention also provides an aqueous fracturing fluid comprising an aqueous carrier liquid containing the above self-suspending proppant.

In addition, this invention further provides a method for fracturing a geological formation comprising pumping this fracturing fluid into the formation.

### DETAILED DESCRIPTION

### Proppant Particle Substrate

As indicated above, the self-suspending proppants which are made humidity-resistant in accordance with this invention take the form of a proppant particle substrate carrying a coating of a hydrogel-forming polymer.

For this purpose, any particulate solid which has previously been used or may be used in the future as a proppant in connection with the recovery of oil, natural gas and/or natural gas liquids from geological formations can be used as the proppant particle substrate of the improved self-suspending proppants of this invention. In this regard, see our earlier filed applications mentioned above which identify many different particulate materials which can be used for this purpose. As described there, these materials can have densities as low as ˜1.2 glcc and as high as ˜5 g/cc and even higher, although the densities of the vast majority will range between ˜1.8 g/cc and ˜5 g/cc, such as for example ˜2.3 to ˜3.5 g/cc, ˜3.6 to ˜4.6 g/cc, and ˜4.7 g/cc and more.

Specific examples include graded sand, resin coated sand including sands coated with curable resins as well as sands coated with precured resins, bauxite, ceramic materials, glass materials, polymeric materials, resinous materials, rubber materials, nutshells that have been chipped, ground, pulverized or crushed to a suitable size (e.g., walnut, pecan, coconut, almond, ivory nut, brazil nut, and the like), seed shells or fruit pits that have been chipped, ground, pulverized or crushed to a suitable size (e.g., plum, olive, peach, cherry, apricot, etc.), chipped, ground, pulverized or crushed materials from other plants such as corn cobs, composites formed from a binder and a filler material such as solid glass, glass microspheres, fly ash, silica, alumina, fumed carbon, carbon black, graphite, mica, boron, zirconia, talc, kaolin, titanium dioxide, calcium silicate, and the like, as well as combinations of these different materials. Especially interesting are intermediate density ceramics (densities ˜1.8-2.0 g/cc), normal frac sand (density ˜2.65 g/cc), bauxite and high density ceramics (density ˜5 g/cc), just to name a few. Resin-coated versions of these proppants, and in particular resin-coated conventional frac sand, are also good examples.

All of these particulate materials, as well as any other particulate material which is used as a proppant in the future, can be used as the proppant particle substrate in making the humidity-resistant self-suspending proppants of this invention.

### Hydrogel Coating

As indicated above, the hard water tolerant self-suspending proppants of this invention are composed of a proppant particle substrate and a coating on this particle substrate comprising a hydrogel-forming polymer. They are made in such a way that
(1) they rapidly swell when contacted with their aqueous fracturing fluids,
(2) they form hydrogel coatings which are large enough to significantly increase their buoyancy during transport downhole, thereby making these proppants self-suspending during this period,
(3) these hydrogel coatings are also durable enough to remain substantially intact until these proppants reach their ultimate use locations downhole, and
(4) these hydrogel coatings remain largely unaffected by any monovalent or divalent ions such as sodium, potassium, calcium and magnesium that might be present in the make-up water used to form these fracturing fluids as well as the geological water they may encounter downhole.
   In this context, “self-suspending” means that a proppant requires a lower viscosity fluid to prevent it from settling out of suspension than would otherwise be the case. In addition, “substantially intact” means that the hydrogel coating is not substantially dislodged prior to the proppant reaching its ultimate use location downhole.

In accordance with this invention, this is accomplished by (1) selecting as the hydrogel-forming polymer chitosan or other naturally occurring cationic polymer such as a cationic polysachharide, (2) by applying a coating of this hydrogel-forming polymer on the proppant particle substrate of the proppant by means of an alkaline solution or emulsion, and optionally and preferably (3) by pretreating the proppant particle substrate with a silane coupling agent which includes a reactive functional group capable of reacting with the pendant amino groups on the chitosan molecule or the analogous pendant electronegative group of chitosan analog.

Chitosan is a linear polysaccharide composed of randomly distributed β-(1-4)-linked D-glucosamine (deacetylated unit) and N-acetyl-D-glucosamine (acetylated unit). It is made by the chemical extraction of chitin from shrimp and other crustacean shells followed by deacylation of the chitin with aqueous sodium hydroxide to chitosan. The chemical structures of both chitin and chitosan are shown below:

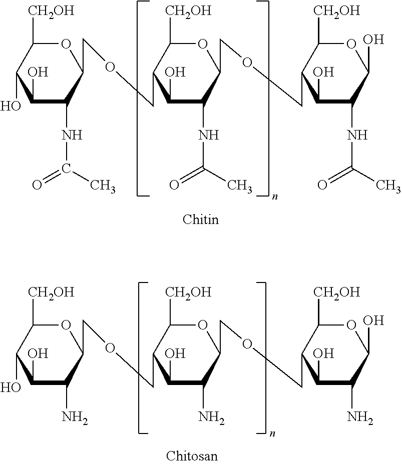

The chemical extraction of chitin from these shells is based on demineralization (or decalcification) by contact of the shells with acid and deproteination of the shells by contact with alkali. These steps, i.e., decalcification and deproteination, can occur in either order, with the properties of the chitosan ultimately obtained being determined in large part by the conditions of the chitin extraction including the order in which these steps are performed. See, Lertsutthiwong, et al. Effect of Chemical Treatment on the Characteristics of Shrimp Chitosan, Journal of Meal, Materials and Minerals, Vol. 12, No. pp 11-18, 2002.

Once produced, chitosan is normally dried into the form of a fine powder, which is the form in which it is usually supplied in commerce. Powdered chitosan is insoluble in most organic solvents as well as water at neutral pH. It dissolves in aqueous acidic solutions as well as aqueous alkaline solutions.

In accordance with this invention, it has been found that self-suspending proppants which are free flowing when dry and further which are both durable and remain largely unaffected by calcium ions and magnesium ions when suspended in water can be made by (1) selecting chitosan or analog as their hydrogel-forming polymer, (2) by applying a coating of this hydrogel-forming polymer on the proppant particle substrate of the proppant by means of an alkaline solution or emulsion, and (3) by pretreating the proppant particle substrate with a silane coupling agent which includes a reactive functional group capable of reacting with the pendant amino groups on the chitosan molecule.

Preferably, the alkaline solution or emulsion has a pH of 9-15.5, more desirably 10-15 or even 11-14.5 and a viscosity of 50-1000 cPs, preferably 100-400 cPs. A pH of about 14 is especially preferred. In addition to sodium hydroxide, any other conventional base can be used for achieving the desired pH, examples of which include ethanolamine, ethylamine or ammonia and other organic or inorganic bases.

Self-suspending proppants manufactured made from anionic hydrogel-forming polymers are sensitive to the salt content of water, especially to hardness metal ions, as reflected by the extent to which they swell when hydrated. They may also be adversely affected by any acid that may be present in the fracing fluids in which they are contained. Monovalent ions such as sodium and potassium can also reduce the swellability of their hydrogel coatings. These problems are avoided by the inventive proppants, because the chitosan or analogous polymer coatings form which they are made maintain their ability to hydrate and swell regardless of the quality (hardness and total dissolved solids) of the pumping fluid. In addition, because these hydrogel-forming polymers are anchored to their proppant particle substrates with silane coupling agents capable of reacting with, and hence forming chemical bonds with, the pendant amino groups on these polymers, they remain firmly affixed to their proppant particle substrate even when subjected to high shear forces and/or other significant mechanical stress.

In addition to chitosan, any other analogous cationic naturally occurring polymer can be used to make the hydrogel-forming coatings of this invention. Such polymers can have linear or cyclic carbon chain and may contain in addition to, or in lieu of, pendant amino groups other pendant functional groups such as hydroxyl, carboxyl, carbonyl and other functional groups. These polymers can be regarded as containing an —(Rₓ)-M moiety in which

M is C, O, N, S, P.

X=1-8, preferably 4-6, and

n=1-1,000,000 preferably 200,000-600,000.

An example of such other analogous cationic naturally occurring polymers are the cationic polysaccharides other than citosan.

More specific examples include starches and modified starches such as cationic starches, anionic starches, amphoteric starches, acid-modified starches, alkylated starches, oxidized starches and pre-gelatinized starches. Additional examples include other naturally-occurring polysaccharides such as cellulose and dextrin, as well as derivatives of these polysaccharides in which one or more pendant hydroxyl groups of the constituent monosaccharide units have been replaced by another functional group such as amino, quaternary amino, ammonium, phosphonium, oxonium and sulfoniurn, as well as acid-modified, alkylated and oxidized versions of such polysaccharides. Blends of these starches and other polysaccharides with other polymers can also be used, provided that the total amount of polysaccharide in the blend is at least 50 wt. %. Blends in which the total amount of polysaccharide is at least 60 wt. %, 70 wt. %, 80 wt. %, or even 90 wt. %, are more interesting. Such blends in which the other polymer is a cationic or anionic polyacrylamide are especially interesting.

An important yet optional feature of this invention is that the proppant particle substrate of the inventive self-suspending proppants is pretreated with a reactive silane coupling agent before it is contacted with the aqueous alkaline coating composition containing the hydrogel-forming polymer. Vinyl silanes such as vinyl trimethoxy silanes, vinyl ethoxy silanes and other vinyl alkoxy silanes in which the alkyl group independently have from 1 to 6 carbon atoms can be used. In addition, such reactive silane coupling agents can be made with reactive groups other than vinyl, examples of which include epoxy, glycidyl/epoxy, allyl, and alkenyl and R2 may be alkyl or aryl or a combination of the two. Such silanes can be regarded as having the formula

R₁—Si—(OR₂)₃

where R₁ may be vinyl, glycidyl/epoxy, allyl, and alkenyl and R₂ may be alkyl or aryl or a combination of the two. Generally speaking, these reactive groups will contain no more than 10 carbon atoms.

The chemistry of silane coupling agents is highly developed, and those skilled in the art should have no difficulty in choosing particular reactive silane coupling agents for use in particular embodiments of this invention.

The amount of cationic, naturally-occurring hydrogel-forming polymer (on a dry solids basis) which is applied to the proppant particle substrate will generally be between about 0.1-10 wt. %, based on the weight of the proppant particle substrate. More commonly, the amount of anionic hydrogel-forming polymer which is applied will generally be between about 0.5-5 wt. %, based on the weight of the proppant particle substrate. Within these broad ranges, polymer loadings of ≦4 wt. %, ≦3 wt. %, ≦2 wt. %, and even ≦1.5 wt. %, are interesting.

These amounts of hydrogel-forming polymer will generally be sufficient so that the volumetric expansion of the inventive proppants, as determined by the Settled Bed Height Analytical test described immediately below is desirably ≧˜1.5, ≧˜3, ≧˜5, ≧˜7, ≧˜8, ≧˜10, ≧˜11, ≧˜15, ≧˜17, or even ≧˜28. Of course, there is a practical maximum to the volumetric expansion the inventive proppants can achieve, which will be determined by the particular type and amount of anionic hydrogel-forming polymer used in each application.

The Settled Bed Height Analytical Test mentioned above can be carried out in the following manner: In a 20 mL glass vial, 1 g of the dry modified proppant to be tested is added to 10 g of water (e.g., tap water) at approximately 20° C. The vial is then agitated for about 1 minute (e.g., by inverting the vial repeatedly) to wet the modified proppant coating. The vial is then allowed to sit, undisturbed, until the hydrogel polymer coating has become hydrated. The height of the bed formed by the hydrated modified proppant can be measured using a digital caliper. This bed height is then divided by the height of the bed formed by the dry proppant. The number obtained indicates the factor (multiple) of the volumetric expansion. Also, for convenience, the height of the bed formed by the hydrated modified proppant can be compared with the height of a bed formed by uncoated proppant, as the volume of uncoated proppant is virtually the same as the volume of a modified proppant carrying a hydrogel coating, when dry.

Another feature of the hydrogel coatings of the inventive proppants is that they rapidly swell when contacted with water. In this context, “rapid swelling” will be understood to mean that the significant increase in buoyancy the inventive proppants exhibit as a result of these coatings is achieved at least by the time these modified proppants, having been mixed with their aqueous fracturing liquids and charged downhole, reach the bottom of the vertical well into which they have been charged such as occurs, for example, when they change their direction of travel from essentially vertical to essentially horizontal in a horizontally drilled well. More typically, these coatings will achieve this substantial increase in buoyancy within 30 minutes, within 10 minutes, within 5 minutes, within 2 minutes or even within 1 minute of being combined with their aqueous fracturing liquids. As indicated above, this generally means that hydration of the anionic hydrogel-forming polymers used will be essentially complete within 2 hours, or within 1 hour, or within 30 minutes, or within 10 minutes, or within 5 minutes, or within 2 minutes or even within 1 minute of being combined with an excess of water at 20° C. As further indicated above “essentially complete” hydration in this context means that the amount of volume increase which is experienced by the inventive modified proppant is at least 80% of its ultimate volume increase.

A third important feature of the hydrogel coatings of the inventive self-suspending proppants is that they are durable in the sense of remaining largely intact until these modified proppants reach their ultimate use locations downhole. In other words, these hydrogel coatings are not substantially dislodged prior to the modified proppants reaching their ultimate use locations downhole.

In this regard, it will be appreciated that proppants inherently experience significant mechanical stress when they are used, not only from pumps which charge fracturing liquids containing these proppants downhole but also from overcoming the inherent resistance to flow encountered downhole due to friction, mechanical obstructions, sudden changes in direction, etc. The hydrogel coatings of our self-suspending proppants, although inherently fragile due to their hydrogel nature, nonetheless are durable enough to resist these mechanical stresses and hence remain largely intact until they reach their ultimate use locations downhole.

For the purposes of this invention, coating durability can be measured by a Shear Analytical Test described in which the proppants are sheared at about 550 s⁻¹ for 20 minutes. (For anionic hydrogel-forming polymers which take more than 20 minutes to hydrate, longer shear times can be used.) A hydrogel coating is considered durable if the settled bed height of the proppant after being subjected to this shearing regimen, when compared to the settled bed height of another sample of the same proppant which has not be subjected to this shearing regimen, (“shearing ratio”) is at least 0.2. Modified proppants exhibiting shearing ratios of >0.2, ≧0.3, ≧0.4, ≧0.5, ≧0.6, ≧0.7, ≧0.8, or ≧0.9 are desirable.

In addition to shearing ratio, another means for determining coating durability is to measure the viscosity of the supernatant liquid that is produced by the above Shear Analytical Test after the proppant has had a chance to settle. If the durability of a particular proppant is insufficient, an excessive amount of its hydrogel polymer coating will become dislodged and remain in the supernatant liquid. The extent to which the viscosity of this liquid increases is a measure of the durability of the hydrogel coating. A viscosity of about 20 cps or more when a 100 g sample of modified proppant is mixed with 1 L of water in the above Shear Analytical test indicates insufficient coating durability. Desirably, the viscosity of the supernatant liquid will be about 10 cps or less, more desirably about 5 cps or less.

The hard water resistant self-suspending proppants of this invention will normally be stored and shipped in dry form. Then, after delivery to the ultimate customer, they will be combined with water and other optional chemicals to make an aqueous fracturing fluid, which will be used to fracture geological formations by pumping the fracturing fluid so made downhole.

The hard water resistant self-suspending proppants of this invention are also desirably formulated to be free-flowing when dry. Preferably, they are formulated to be free-flowing after being subjected to a relative humidity of between about 80%-90% for one hour at 25-35° C.

### EXAMPLE

To demonstrate the importance of using a reactive silane coupling agent in connection with making the inventive hard water tolerant self-suspending proppants, several self-suspending proppants were made using chitosan as the hydrogel-forming polymer. One of these self-suspending proppants, which was made in accordance with this invention, was made with a vinyl triethoxy silane coupling agent. Of the other two, one was made with no silane coupling agent while the other was made with a conventional silane coupling having no reactive functional group, i.e., gamma-aminopropyl trimethoxy silane. When subjected to the same shear durability test, the following results were obtained:

| | Settled Bed height (SBH in | |
|---|---|---|
| Binder | mm)/swelling (in %) | Comment |
| No binder | 11 (0%) | Polymer sheared off |
| 3-aminopropyl- | 11 (0%) | Polymer sheared off |
| trimethoxy silane | | |
| Vinyl triethoxy | 22 (100%)- | No polymer shearing |
| silane 22 (100%) | | noted |

1. A self-suspending proppant comprising a proppant particle substrate and a coating on the proppant particle substrate comprising chitosan or a chitosan analog comprising another naturally occurring cationic polymer other than chitosan, wherein the coating has been applied to the proppant particle substrate of the proppant by means of an alkaline solution or emulsion.

2. The self-suspending proppant of claim 1, wherein coating comprises chitosan, and further wherein prior to application of the coating the proppant particle substrate has been treated with a silane coupling agent which includes a reactive functional group capable of reacting with the pendant amino groups on the chitosan molecule.

3. The self-suspending proppant of claim 1, wherein coating comprises a chitosan analog.

4. The self-suspending proppant of claim 3, wherein the chitosan analog is a cationic polysaccharide other than chitosan.

5. The self-suspending proppant of claim 4, wherein the chitosan analog is an unmodified starch or a modified starch selected from the group consisting of cationic starches, anionic starches, amphoteric starches, acid-modified starches, alkylated starches, oxidized starches and pre-gelatinized starches.

6. The self-suspending proppant of claim 4, wherein the chitosan analog is a cellulose or dextrin.

7. The self-suspending proppant of claim 6, wherein the cellulose or dextrin includes monosaccharide units having pendant hydroxyl groups and further wherein one or more pendant hydroxyl groups have been replaced by a functional group selected from the group consisting of amino, quaternary amino, ammonium, phosphonium, oxonium and sulfonium.

8. The self-suspending proppant of claim 3, wherein the chitosan analog has a pendant electronegative group, and further wherein prior to application of the coating the proppant particle substrate has been treated with a silane coupling agent which includes a reactive functional group capable of reacting with the pendant electronegative group of the chitosan analog molecule.

9. The self-suspending proppant of claim 2, wherein the self-suspending proppant is free-flowing when dry.

10. The self-suspending proppant of claim 9, wherein the self-suspending proppant is free-flowing after having been subjected to a relative humidity of between about 80%-90% for one hour at 25-35° C.

11. The self-suspending proppant of claim 10, wherein the self-suspending proppant remains self-suspending after having been subjected to shear at about 550 s⁻¹ for 20 minutes.

12. The self-suspending proppant of claim 2, wherein the self-suspending proppant remains self-suspending after having been subjected to shear at about 550 s⁻¹ for 20 minutes.

13. A process for making a self-suspending proppant comprising a proppant particle substrate and a coating on the proppant particle substrate comprising chitosan or a chitosan analog comprising another naturally occurring cationic polymer other than chitosan, the process comprising coating the proppant particle substrate with an alkaline solution or emulsion of the chitosan or a chitosan analog and then drying the coated proppant so formed.

14. The process of claim 13, wherein prior to application of the coating the proppant particle substrate is treated with a silane coupling agent which includes a reactive functional group capable of reacting with the pendant amino groups on the chitosan molecule.

15. The process of claim 13, wherein coating comprises a chitosan analog.

16. The process of claim 13, wherein the chitosan analog is a cationic polysaccharide other than chitosan.

17. The process of claim 16, wherein the chitosan analog is an unmodified starch or a modified starch selected from the group consisting of cationic starches, anionic starches, amphoteric starches, acid-modified starches, alkylated starches, oxidized starches and pre-gelatinized starches.

18. The process of claim 16, wherein the chitosan analog is a cellulose or dextrin.

19. The process of claim 18, wherein the cellulose or dextrin includes monosaccharide units having pendant hydroxyl groups and further wherein one or more pendant hydroxyl groups have been replaced by a functional group selected from the group consisting of amino, quaternary amino, ammonium, phosphonium, oxonium and sulfonium.

20. The process of claim 15, wherein the chitosan analog has a pendant electronegative group, and further wherein prior to application of the coating the proppant particle substrate has been treated with a silane coupling agent which includes a reactive functional group capable of reacting with the pendant electronegative group of the chitosan analog molecule.

21. An aqueous fracturing fluid comprising an aqueous carrier liquid and the self-suspending proppant of claim 1.

22. A method for fracturing a geological formation comprising pumping the fracturing fluid of claim 21 into the formation.
